(19) United States
(12) Patent Application Publication
(10) Pub. No.: US 2011/0307403 A1
(43) Pub. Date: Dec. 15, 2011

(54) Systems and method for providing monitoring of social networks

(76) Inventors: Arad Rostampour, San Bruno, CA (US); Noah Benjamin Suojanen Kindler, San Bruno, CA (US); Russell Douglas Fradin, San Bruno, CA (US); Steven Cury Heyman, San Bruno, CA (US)

(21) Appl. No.: 13/159,115

(22) Filed: Jun. 13, 2011

Related U.S. Application Data
(60) Provisional application No. 61/354,096, filed on Jun. 11, 2010.
(60) Provisional application No. 61/427,573, filed on Dec. 28, 2010.

(51) Int. Cl. G06Q 99/00

(52) U.S. Cl. 705/325

(57) ABSTRACT

A method is provided of monitoring activity relative to a user's account of an on-line social network website (OSN). At least one activity of the user's account on an OSN is monitored, resulting in user's account activity data. Analysis of the user's account activity data is performed. Information is reported that is indicative of the processed user's account activity based on a selected criteria. A system is provided for authenticating a parent or legal guardian of a child on a social network.

### CROSS-REFERENCE TO RELATED APPLICATIONS

This application claims the benefit of U.S. 61/354,096 filed Jun. 11, 2010 and U.S. 61/427,573 filed Dec. 28, 2010, both of which applications are fully incorporated herein by reference

### BACKGROUND

1. Field of the Invention

The present invention is generally directed to on-line social networks, and more particularly to systems and methods to monitor service of an on-line social networks.

2. Brief Description of the Related Art

The amount of time that consumers spend on the Internet has steadily increased, as has the variety of web content, such that the Internet is often the first place many people turn to when searching for information, news, or entertainment. Consumers use a variety of methods to search for desired information on the Internet such as entering terms in a search engine. Over time, a user may develop a list of relevant sites based on a number of different topics. However, the constantly increasing number of websites has increased the time and effort it takes to weed through relevant websites.

On line-social networks (“OSNs”) provide another method for consumers to more quickly locate websites of interest. The most common usage of an OSN is to share personal information with friends, such as status updates, photos, videos, notes, comments, or to communicate with friends, such as using messaging/email or chat. Users may also “tag” a website by associating a term or label with the website allowing the categorization of different sites based on the tag. Users may also “tag” items within the OSN, such as notes, comments, photos, videos, or location information.

OSN sites such as MySpace and Facebook allow individuals to connect over the Internet for various purposes from business networking, sharing common interests, sharing personal information such as pictures, videos, comments, and the like, communicating with friends, dating and the like. Individuals generally have the ability to represent themselves however they choose, through these OSNs, simply by creating an account and providing whatever details they would like to share with the other users of the OSN.

While many individuals are honest in their self-representations, other individuals attempt to pass themselves off as being older or younger than they really are, or of a different gender, for example. Often, such misrepresentations are done for the purpose of taking advantage of other users of the OSN, especially children, sometimes for criminal ends. Even if they represent themselves accurately, they may have ill-intentions or send communications that are not suitable for children.

An additional problem that has arisen in OSNs is the problem of impersonation, where someone gains unauthorized access to an existing account of a legitimate user. With the unauthorized access, the impersonator can post content and/or communicate with other users, typically in a manner that the legitimate user would find objectionable. Such impersonations can both damage the reputation of the legitimate user and harm other users. Other problems are just as dangerous such as, a child talking about suicide, over-sharing information that could cause a safety or reputation concern, making inappropriate friends, attending inappropriate events, joining inappropriate groups, and the like.

### SUMMARY

Accordingly, an object of the present invention is to provide systems and methods for monitoring OSN activities.

Another object of the present invention is to provide systems and methods for monitoring OSN activities and sending alerts.

A further object of the present invention is to provide systems and methods for monitoring OSN activities and conducting analysis of at least one of, (i) postings such as status updates, comments, notes, or questions, (ii) keyword matching for discussions of at least one of drugs, sex, violence, illegal activity, suicide, and other topics of concern. (iii) at least one of uploading pictures, uploadingvideo, being tagged in pictures, and being tagged in videos, (iv) identification of user in a picture or video, (v) friend information, determination of suspiciousness, or friend activity, (vi) messaging or chat activity, (vii) link sharing and (viii) events, and (ix) joining groups, and (x) sharing location.

Yet another object of the present invention is to provide monitoring, analysis of OSN activities, and alerts that are sent to the user for specific types of activities based on analysis of the data.

Still another object of the present invention is to provide systems and methods for monitoring OSN activities including the aggregation of information across multiple sites and multiple people.

Another object of the present invention is to provide systems and methods for monitoring OSN activities and adding logic and analysis to highlight further causes of concern, including but not limited to, suspicious activity, comments, messages, chats, friends, photos and the like.

A further object of the present invention is to provide systems and methods for authenticating a parent on an OSN.

Yet another object of the present invention is to provide systems and methods for authenticating a parent on an OSN by, (i) parents signing up for a parent account and receiving a unique code, their child enters its code in a child account and the parent (or guardian) and obtains validation of the account as it indicates that the child believes that the adult can monitor the account and (ii) the parent may create an account for the child, which then gives access as the child uses it, and the like.

These and other objects of the present invention are achieved in a method of monitoring activity relative to a user's account of an on-line social network website (OSN). At least one activity of the user's account on an OSN is monitored, resulting in user's account activity data. Analysis of the user's account activity data is performed. Information is reported that is indicative of the processed user's account activity based on a selected criteria.

In another embodiment of the present invention, an apparatus to monitor activity relative to a user's account of an OSN includes a monitoring unit configured to monitor at least some activities of the user's account on an OSN resulting in user's account activity data. A processing unit is configured to process the user's account activity data. A reporting unit is provided to report information indicative of the processed user's account activity based on a selected criteria.

In another embodiment, an OSN system includes enrollment logic configured to enroll a child in the OSN to create a child account by associating the child and with a user ID. Authentication logic authenticates a parent of the child. The authenticating logic executes parent authentication by at least one of, (i) parents sign up for a parent account and receive a unique code, the child enters its code in the child account and the parent or guardian and obtains validation of the account as it indicates that the child believes that the adult can monitor the account, (ii) the parent creates an account for the child, which then gives access as the child uses it, (iii) the parent is issued a code and conveys to the child to enter that code to confirm a relationship, and (iv) the child is issued a code and conveys to the parent to enter that code to confirm a relationship.

### BRIEF DESCRIPTION OF THE DRAWINGS

FIG. 1 is a flow diagram of an example embodiment of the present invention.

FIG. 2 is a flow diagram of an alternative example embodiment of the present invention.

FIG. 3 is a flow diagram of another alternative embodiment of the present invention.

FIG. 4 is a block diagram illustrating different components of a remote monitor system embodying the present invention.

FIG. 5 is a schematic illustration depicting dataflow according to one embodiment of the present invention.

FIG. 6 is a schematic illustration depicting dataflow according to an alternative embodiment of the present invention.

FIG. 7 is a schematic view of a computer network environment in which the principles of the invention may be implemented.

FIG. 8 is a block diagram of the internal structure of a computer from the FIG. 7 computer network environment.

FIG. 9 is a schematic representation of an exemplary environment for carrying out various methods described herein.

FIG. 10 is a flow-chart representation of an enrollment method according to an exemplary embodiment.

FIG. 11 is a flow-chart representation of an exemplary authentication method according to an exemplary embodiment.

FIG. 12 is a schematic representation of an authentication system according to an exemplary embodiment.

FIG. 13 is a flow-chart representation of an exemplary method for a claimant to be authenticated according to an exemplary embodiment.

FIG. 14 is a flow-chart representation of a method for preventing a user from making certain misrepresentations in an OSN according to an exemplary embodiment.

FIG. 15 is a flow-chart representation of a method for maintaining an OSN according to an exemplary embodiment.

### DETAILED DESCRIPTION

In one embodiment of the present invention, systems and methods are provided to monitor service of OSNs. In one embodiment, a user's account information for an OSN to be monitored is acquired. In another embodiment, permission is received from the user and a token is received that grants access to the data with having account login/password. This can be achieved with a manual process of entering credentials, a request to authorize such credentials through a web service, a more automated way through installed software, approving permission for an application within an OSN, and the like. The present invention can be utilized for multiple OSN's as well as for multiple users. With this information, as much information as possible or relevant from each OSN for each user is retrieved. This can be achieved with software on the user's computer, with a web service pulling data from the web site, an Application Programming Interface, API and the like.

The data across multiple OSNs can be aggregated for a user. For multiple users, it can be further aggregated for the group of users. As a non-limiting example, this could be a parent monitoring multiple children.

For each specific category of data, additional analysis is done. Categories include, but are not limited to: activity, photos, friends, videos, messages, chats, status updates, comments, questions, notes, groups, events, location, and any other information shared in the OSN.

Examples of analysis include, but are not limited to, (i) postings including status updates, comments, notes and questions, (ii) keyword matching for discussions of at least one of drugs, sex, violence, illegal activity, suicide, and other topics of concern. (iii) at least one of uploading pictures, uploading video, being tagged in photos, and being tagged in videos, (iv) identification of a user in at least one of a picture and video, (v) friend information, (vi) determination of suspiciousness, (vii) friend activity, (viii) messaging activity (ix)chat activity, (x) link sharing and (xi) events and (xii) location and the like.

Information from OSNs, as well as the analysis data, can be presented to the user. This can be in the form of a web site, email, mobile notification, phone call, paper copy and the like.

If certain items are of higher priority or an alert generated, they can be communicated to the user separately from the aggregated data. Obtaining user credentials or permission for the OSN and acquiring at least one type of data from the OSN is required. In another embodiment, credentials are not needed and access to the data can be achieved via the API by receiving permission. These elements may be repeated for multiple OSN's or multiple people. The aggregation, presentation, and analysis of such data can be independently completed and implementations of the invention may choose to do a subset of these elements.

In one embodiment, one or more steps of analysis is performed. Each step may have multiple sources or categories, and may choose to do one or more of the sources or categories. The aggregation, presentation, and analysis of data may be done independently. The individual elements are performed by a computer program, either one which is installed on the user's computer, or a website service. Credentials are acquired either manually from the user or automatically from the computer program, or just permission to access data from within the OSN using the API, data from the OSN is acquired either by access on the local computer, retrieving information from the website, calling an application programming interface (API), or other means of access to the OSN. This can be repeated for multiple OSN of a user, and then may be repeated for multiple users. This data may be aggregated to show a single view of all of the data. This data may be presented to the user via web, email, text/SMS, phone call, push notification, or paper copy. Additionally, each of the different kinds of analysis may be performed by the computer program, and results or alerts may be presented to the user.

In one embodiment, software can be loaded or a person can sign up with a third party monitoring software site, providing the information on the user of an OSN, and then taking steps necessary to have the computer program gain access to information within the OSN. Examples include but are not limited to, providing credentials, authenticating, validating API access, or other means to enable access to the data.

The monitoring service can monitor such OSN data and present it to the user in different forms including but not limited to, web, email, text/SMS, phone call, push notifications, paper copy and the like. Alerts may be sent to the user for specific types of activities based on analysis of the data.

The systems and the methods of the present invention provide a monitoring service, aggregating information across multiple sites and multiple people. As a non-limiting example, a parent can monitor multiple children, and this can be presented in multiple forms Such forms include but are not limited to at least one of, a website dashboard, email digest, alerts by, phone, SMS/text, email, push notifications and the like.

In one embodiment, the systems and methods of the present invention add logic and analysis to highlight further causes of concern, including but not limited to suspicious activity, comments, messages, chats, friends, events, groups, location, video, photos and the like. Such logic can create alerts based on this information to highlight specific items, and these alerts can be delivered to the user via the web, email, phone, text/SMS, push notifications, or paper copy.

Other solutions do not aggregate data across multiple networks and multiple people in a similar fashion to form a more complete view of online presence, and then add analysis and monitoring features to present to the user. This analysis includes finding areas of concern and alerting a user if configured.

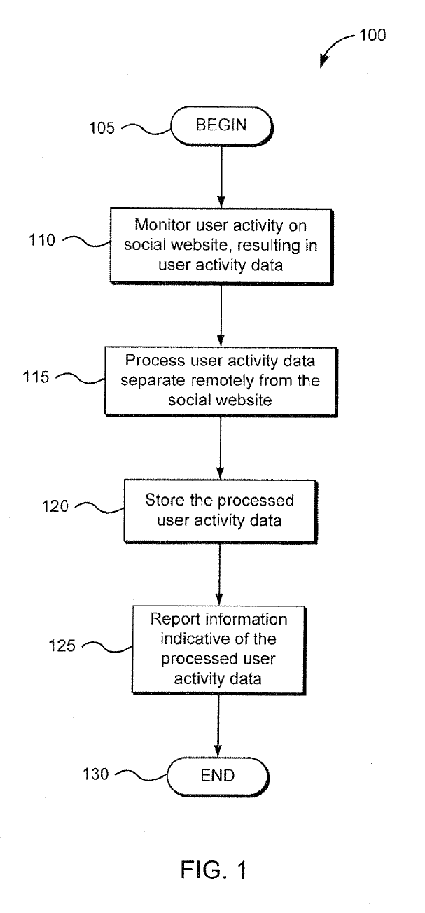

Referring now to FIG. 1, a flow diagram illustrating an example embodiment of monitoring an OSN is shown. The process 100 begins 105 and monitors user activity on an OSN at step 110. The monitoring step/process results in user activity data such as that described above. The resulting user activity data is processed within the OSN, separately, or remotely from the OSN that step 115. After processing step 115, the invention process 100 may store (step 120) processed user activity data in, for example, a searchable data store. Information indicative of the processed user activity data may be reported at step 125. The process 100 may then end 130.

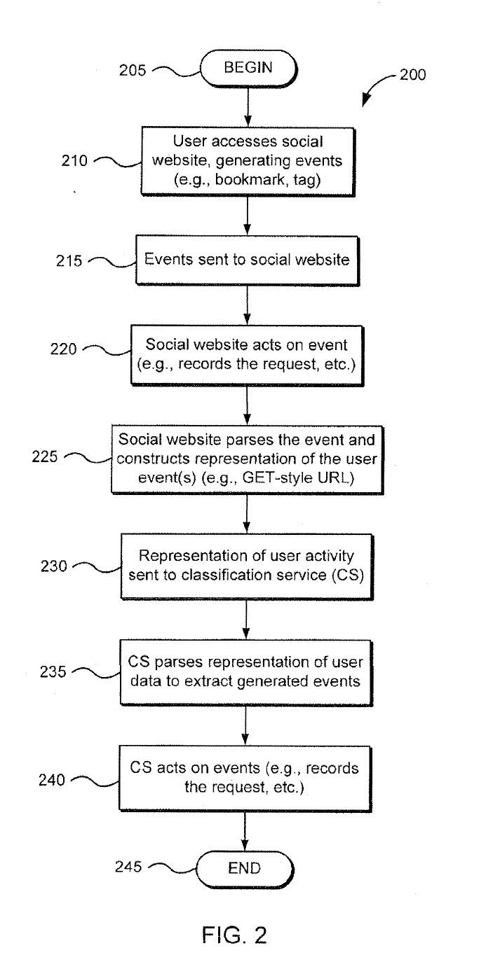

FIG. 2 is a flow diagram illustrating an alternative example embodiment of the invention. The invention process 200 begins 205 with a user accessing an OSN 210 whereby a variety of events are generated (step 210).

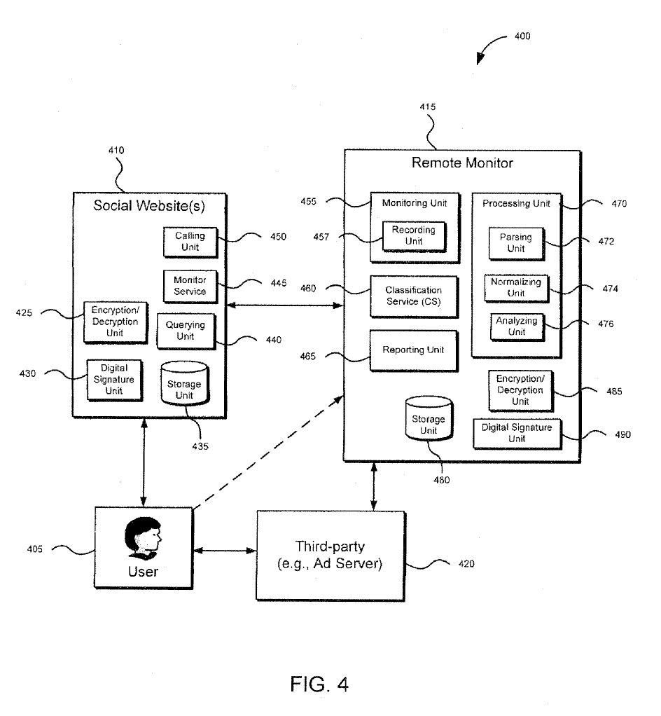

The OSN 410 may act on the events (step 220 (CS) 460 (in FIG. 4) at step 230 in FIG. 2.

The classification service 460 receives the representation of user data and parses it to extract generated events (step 235), such as parameters describing the event that was just recorded, or the URL can remain unparsed and recorded unchanged, for later processing. The classification service 460 then acts on the events (step 240), such as recording the request (or executing whatever code is programmed). The process 200 then ends 245.

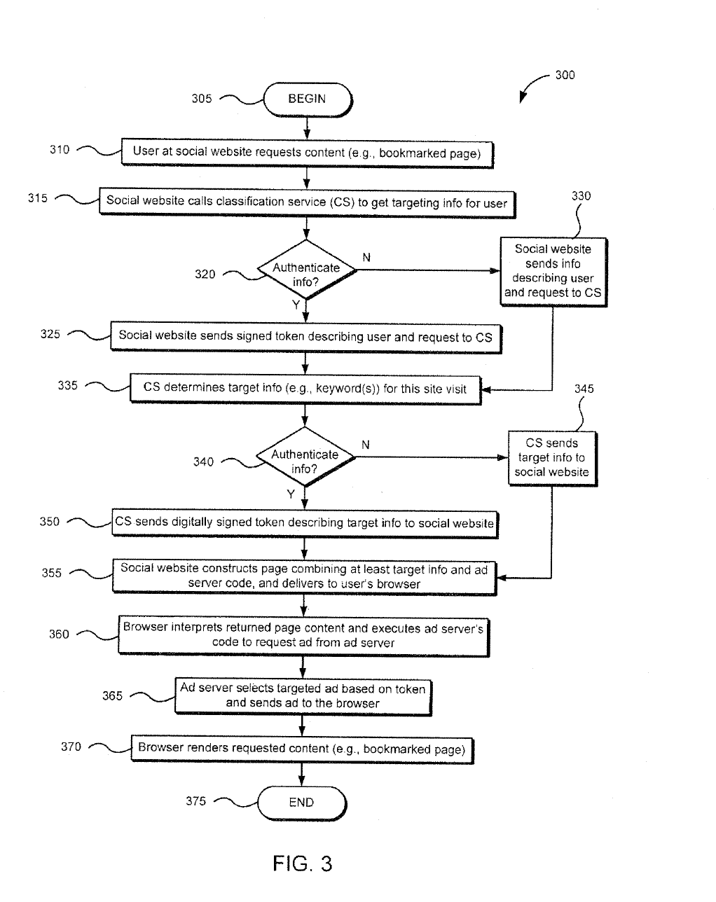

FIG. 3 is a more detailed flow diagram illustrating an example embodiment of the present invention. The process 300 begins 305 with a user 405 at the OSN 410 requesting content (step 310) via a web browser. The OSN 410 then calls a classification service 460 to get targeting information for the user (step 315). To ensure integrity of the received data, the OSN 410 may authenticate the information at step 320. The process 300 continues and at step 325 the OSN 410 sends either a signed token describing the user 405 and request to the classification service 460, or at step 330 sends an unauthenticated version of the information describing the user 405 and request to the classification service 460.

The classification service 460 determines target information at step 335′ such as appropriate keywords and may also record the event. The classification system 460 then sends target information to the OSN at step 345, or may optionally authenticate the information at step 340 and send a digitally signed token describing the target information to the OSN at step 350. The OSN 410 then constructs a webpage combining its own content, the target information and advertisement server code and delivers it to the user at step 355. The user's browser interprets the returned page's content and executes the advertisement server's code to request an ad from the advertisement server 420. Next, the advertisement server 420 selects a targeted ad based on the targeted information or token and then sends the ad back to the user's browser at step 365. After receiving the targeted ad, the users browser renders the process 300 then ends 375.

FIG. 4 is a block diagram of a remote monitoring system 400 according to an example embodiment of the invention. The remote monitoring system 400 may contain a remote monitor 415 which includes a monitoring unit 455, classification service (CS) 460, reporting unit 465, processing unit 470, storage unit 480, encryption/decryption unit 485, and digital signature unit 490. The system 400 may remotely monitor user 405 activity on at least one remote OSN 410. The OSN 410 may include an encryption/decryption unit 425, digital signature unit 430, storage unit 435, querying unit 440, monitor service 445, and calling unit 450. A monitoring service unit 445 may be configured to monitor user activity 405 on a remote OSN 410, resulting in user activity data. The processing unit 470 is configured to process the results user activity data separately from the OSN 410, in a substantially real-time manner, or processed at a later time. The user activity data may be stored in the storage unit 480. The reporting unit 465 may be configured to report information indicative of the processed user activity data.

The monitoring unit 455 may be configured to monitor user 405 activity in response to a call from the OSN's 410 calling unit 450 that may be triggered by the user's activity at the OSN. The call may be an application programming interface (API) call, or similar call known in the art. Alternatively the monitoring unit 455 may be configured to poll the monitor service 445 that is installed on the remote OSN 410 on a periodic, aperiodic, or event-driven basis. In either case, the monitoring unit 455 effectively logs or records the user's activity. In one embodiment the user activity data may be represented in the form of a uniform resource locator (URL). And in another example embodiment, a monitoring unit 455 may be configured to locally track and accumulate user activity at the remote OSN 410, and may communicate the user activity data to the CS 460 where the CS determines user target information on a periodic, aperiodic, or event-driven basis.

The processing unit 470, through use of a parsing unit 472 may parse the user activity data results from the remotely monitored OSN(s)410. The normalizing unit 474 may “normalize” or “standardize” the parsed user activity data. That is, OSNs 410 may store particular data fields using slightly different identifiers. For example, one OSN 410 may store the user's identity in a field labeled “user” and another OSN 410 may store the same information in a field “userID” and still another OSN may use the label “username.” Thus, the invention normalizing unit 474 effectively standardizes non-standardized field names from a variety of OSNs 410 using a common label or identifier allowing the aggregation of user activity data from virtually every OSN, Advantageously, the invention aggregates data from a plurality of OSNs 410 allowing the identification of trends not currently identifiable, such as trends across a large number of users or more broadly such as societal trends. To facilitate this analysis, the storage unit 480 may be configured to store the processed results in a centralized, searchable data store such as a database where the normalizing unit 474 has standardized the results data. Alternatively this information may be distributed across multiple storage units 480 to provide data redundancy, increased search speeds, and other benefits known in the art.

The processing unit 470 may also be configured to perform on-the-fly analysis of the user activity data, or alternatively, may store the user activity data for analysis at a later time. The querying unit 440 of the OSN 410 may also be configured to query the CS 460 before the OSN displays the user requested page where the CS 460 determines user target information. In an example embodiment, the reporting unit 465 may be further configured to communicate and transmit the stored process user activity data to a third party, such as an advertisement server 420. The reporting unit 465 may also be configured to report user activity data represented in the form of metadata or other data or file formats known in the art. Alternatively, or in addition, the reporting unit 465 may also be configured to generate a targeted advertisement based on user activity data and may communicate that advertisement to a third-party 420 or to the OSN 410 for display in the user's 405 browser.

The user activity data may be protected using a variety of data protection techniques known to those skilled in the art. For example, the encryption/decryption unit 485 of remote monitor 415 may encrypt data prior to transmitting the data to the OSN 410 where in turn the encryption/decryption unit 425 of the OSN 410 will then decrypt the information. It should be understood that in order to provide effective data protection the encryption/decryption process may occur throughout the entire chain of data transmission, including but not limited to, from the OSN 410 to the remote monitor 415, from the remote monitor 415 to the third-party server 420, from the third-party server 420 to the remote monitor 415, and from the remote monitor 415 to the OSN 410. Alternatively, or in addition, the digital signature unit 490 may be used to authenticate data according to data authentication techniques known in the art. This may be useful in circumventing fraudulent requests (e.g., metadata, spam, etc.) from unauthorized third parties, for example, preventing a third-party from writing bogus data to the remote monitoring unit 415.

The OSN 410 may be a website where users are allowed to associate a tag. OSNs have proliferated at an increasingly rapid rate such that there are now hundreds of OSNs currently in operation. The invention 400 may also be used in conjunction with other OSNs 410, such as blogs or any other website that allows the use of tags to be added and/or associated with content.

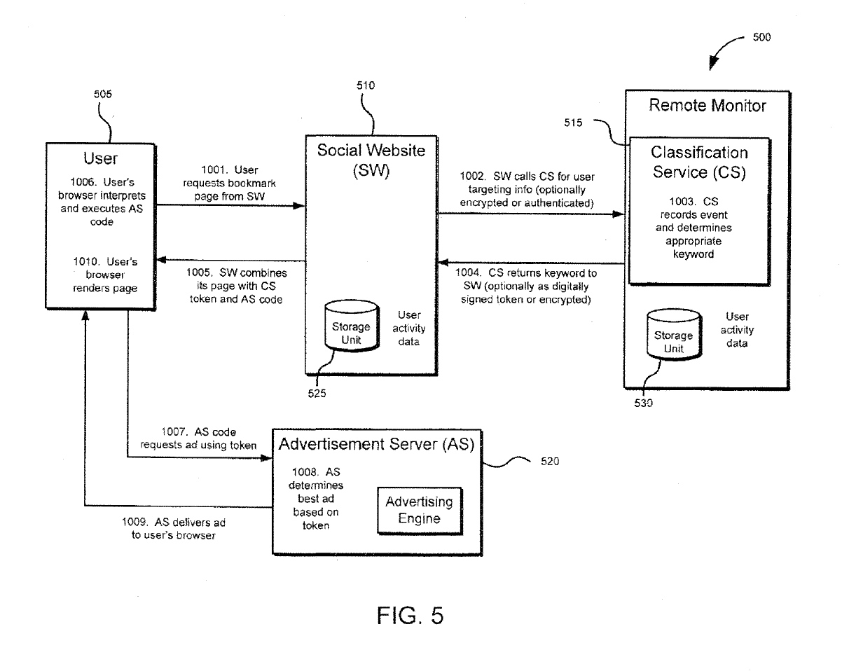

FIG. 5 is a schematic diagram representing data flow in an example embodiment 500 of the invention. The remote monitoring system 500 may comprise a classification system (CS) 515 implemented using, for example, a processor (not shown). A user 505 may request a bookmark page from the OSN 510 (step 1). The OSN 510 then calls the CS 515 in order to obtain user targeting information (step 2). As mentioned above this communication may be encrypted, and digitally signed or otherwise made secure. The CS 515 may record the event in a storage unit 530, such as a searchable database. The CS 515 may also analyze previous and/or current activity data for the user 505 as previously recorded in storage unit 530 in order to determine an appropriate keyword or multiple keywords (step 3). In this embodiment, the CS 515 is guaranteed to record the event before the CS performs its ad selecting analysis.

The CS 515 then returns the determined keyword(s) either as it is, or encrypted, or as a digitally signed token back to the OSN 510 (step 4). The OSN 510 then combines its page with the CS keyword/token and advertisement server code (step 5). Alternatively, the CS can return both the keyword(s) and the advertisement server code together. Next, in response the user's browser interprets the received combined page and executes the advertisement server code (step 6). The advertisement server code may then request an ad using the received keyword/token (step 7). The advertisement server 520 may determine the best ad based on the subject keyword/token (step 8). The advertisement server 520 then delivers the determined ad to the user's browser (step 9) where the user's browser then renders the user's requested page (step 10).

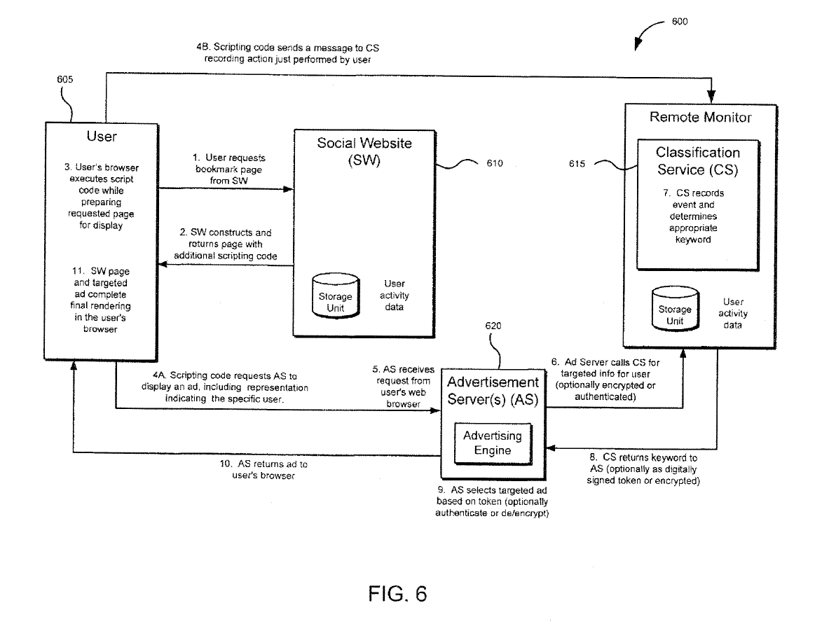

FIG. 6 is a schematic diagram representing data flow in and alternative example embodiment 600 of the invention. This embodiment similarly begins with the user 605 requesting, for example, a bookmark page from the OSN 610 (step 1). Here, however, the OSN 610 constructs a webpage and returns the page to the user 605 with additional scripting code (step 2). The users browser 605 executes the scripting code while preparing the requested webpage for display (step 3). Next, the scripting code may use a forked process to request the advertisement server 620 to display in the ad where the request includes a representation indicating a specific user (step 4A) and may also send a message to the CS 615 recording the action just performed by the user (step 4B). Because this embodiment 600 uses a forked process, the CS 615 is not guaranteed to record the event before the CS performs its ad selecting analysis.

Next, the advertisement server 620 receives a request from the user's web browser 605 (step 5) and then calls the CS 615 for targeted information for that specific user (step 6). The CS 615 responsively analyzes the request and determines an appropriate keyword (step 7). The CS 615 then returns a keyword or digitally signed token to the advertisement server 620 (step 8). If the data was authenticated the advertisement server 620 confirms the token's authenticity using CS's public key or other authentication techniques known to one skilled in the art. Next, the advertisement service 620 selects a targeted ad based on the received token/keyword (step 9) and returns the determined ad to the user's browser 605 (step 10). Then the page returned by the OSN 610 (step 2) is combined with the targeted ad and sent to the user's browser 605 for rendering (step 11).

As mentioned previously, various communications may be made secured digitally signed encrypted/decrypted between the various modules (405, 410, 415, 420, 505, 510, 515, 520, 605, 610, 615, 620) in FIGS. 4, 5 and 6.

The block diagrams of FIGS. 4, 5, and 6 are merely representative and that more or fewer units may be used, and operations may not necessary be divided up as described herein. Also, a processor executing software may operate to execute operations performed by the units, where various units, separately or in combination may represent a processor, field programmable gate array (FPGA), application specific integrated circuit (ASIC), or the like. It should be understood that the block diagrams may, in practice, be implemented in hardware, firmware, or software. If implemented in software, the software may be any form capable of performing operations described herein, stored on any form of computer readable-medium, such as RAM, ROM, CD-ROM, and loaded and executed by a general purpose or application specific processor capable of performing operations described herein.

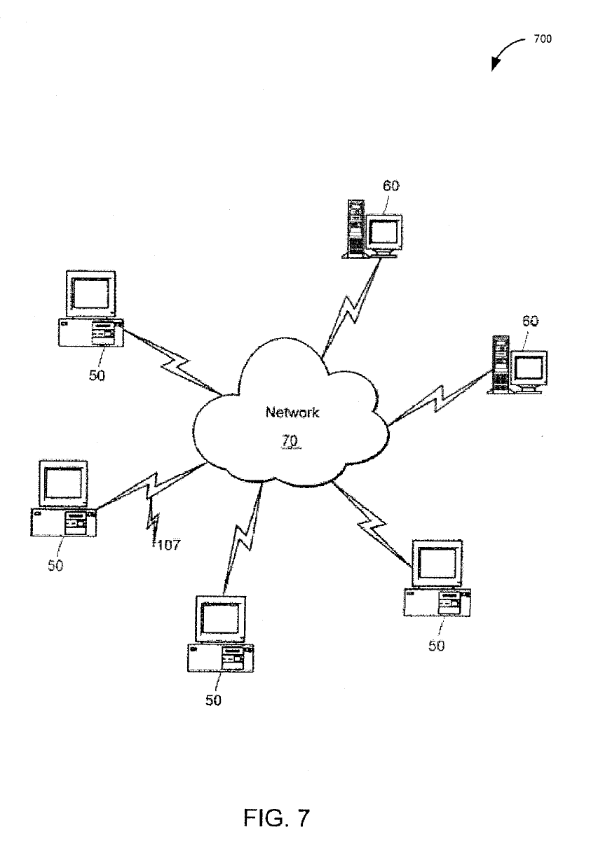

FIG. 7 illustrates a generalized computer network 700 or similar digital processing environment in which the invention may be implemented. Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

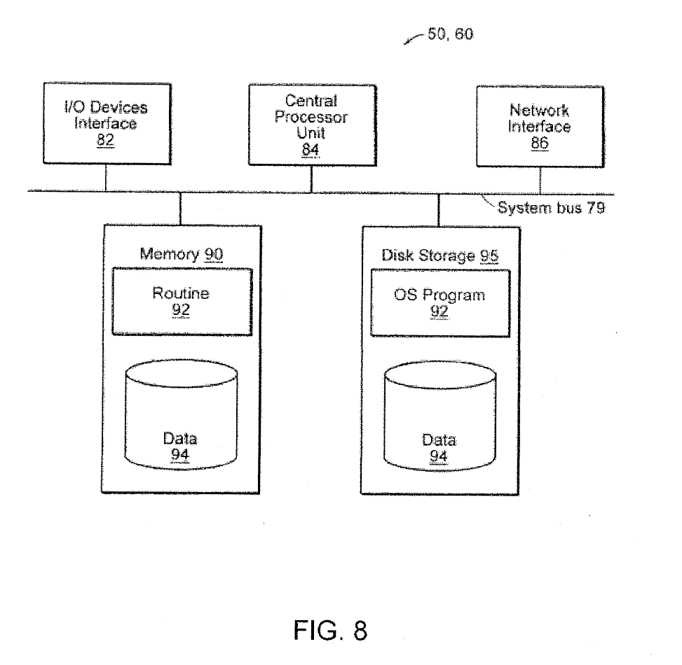

FIG. 8 is a diagram of the internal structure of a computer 50, 60 (e.g., client processor/device 50 or server computers 60) in the computer system of FIG. 7. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 7). Memory 90 provides volatile storage for computer software instructions 92 and data 94 used to implement an embodiment of the present invention (e.g., remote monitoring, processing, storing and reporting code 63 detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like. In some embodiments computer system 40 employs a Windows™ (Microsoft) operating system, in other embodiments a Linux operating system, and in other embodiments a UNIX™ operating system. Other operating systems and system configurations are suitable.

In another embodiment, systems and methods for authenticating a parent on an OSN. This can be achieved in a number of ways, including but not limited to, (i) parents can sign up for a parent account and receive a unique code, their child enters its code in the child account and the parent (or guardian) and obtains validation of the account as it indicates that the child believes that the adult can monitor the account, (ii) the parent may create an account for the child, which then gives access as the child uses it, (iii) the parent is issued a code and conveys to the child to enter that code to confirm a relationship, and (iv) the child is issued a code and conveys to the parent to enter that code to confirm a relationship, and the like.

In another embodiment, the data may be stored under the parents account, not the child's, potentially allowing regulatory advantages. Each step is independent and it is optional for the parent's monitoring/relationship to be known to the friends of the child.

In one embodiment, the parent obtains a special code which the parent then gives to the child. This can be done by physically providing it, email and the like. The child then enters the code providing parental access, monitoring and other privileges. Alternatively, the parent can create an account for the child with the linking already in place. All data can be stored under the parent's account, potentially allowing regulatory advantages. Additionally, the monitoring by the parent can be anonymous so the child need not disclose to others that the parent is monitoring the child's account. The present invention is particularly useful when a parent/child, legal guardian/child and the like is required including but not limited to, music accounts, bank accounts, e-mail accounts and the like.

In an exemplary OSN, the system comprises both enrollment logic and authentication logic. The enrollment logic is configured to enroll users in the OSN by associating each user with a unique user ID. The enrollment logic is further configured to receive an indication of each user's gender and/or. In this way the enrollment logic can certify users. Users that do not wish to be enrolled in this manner may still be enrolled in the OSN, but would not be treated as a certified user of the OSN.

In various embodiments the enrollment logic is further configured to enroll users by receiving an indication of the user's age and verifying the user's.

The present invention also provides methods for maintaining an OSN. An exemplary such method comprises enrolling users in the OSN, wherein enrolling users includes storing in association with a user ID for each enrolled user a voice template, a facial recognition template, and either the user's gender or the user's age. The exemplary method further comprises certifying enrolled users by using their voice template or their facial recognition template to verify their gender and/or age, and indicating to users of the OSN which other users are certified. The exemplary method can further comprise restricting some users to communicate only with certified users, such as those that meet a criterion like gender or age.

The present invention also provides methods for enrolling a user in an OSN. An exemplary enrollment method comprises associating the user with a user ID, associating a plurality of prompts with the user ID. In various embodiments the method further comprises receiving an indication of the user's gender, age, or both, and then verifying the user's gender, age, or both

In one embodiment, systems and methods are provided for authenticating users of OSNs to prevent or at least deter impersonation and misrepresentation. Authentication for OSNs can achieve these ends, according to the present invention, by the use of an authentication system that employs a number of security features in combination. These security features can be based, for example, on unique knowledge of the legitimate user, a unique thing that the user has, unique personal features and attributes of the user, the ability of the user to respond, and to do so in a fashion that a machine cannot, that only a fraction of the authentication information is made available in any one authentication attempt, and so forth.

Yet another security feature can be achieved through the use of two channels of communication between the authentication system and the claimant. To complete the authentication, a second communication channel is established using the device address recorded during the enrollment process. The second channel is different from the communication channel over which the authentication system received the claimant target. Here, the prompt is provided to the claimant over the second channel, and/or the response to the prompt is returned to the authentication system over the second channel. The use of the second channel to the device associated with the previously recorded device address makes fraudulent activity more difficult because a party seeking to perpetrate a fraud would need to have access to some unique thing that the enrolled user has, such as a cell phone. Still further security features, described in more detail below, can also be employed.

Within the context of an OSN, the invention can be used to prevent both impersonations and misrepresentations. Turning first to the problem of impersonation, the invention can prevent a claimant from accessing the account of another user without the authorization of that user in order to impersonate that user. In an OSN that implements the present invention, a user can choose to disclose their true identity or remain anonymous and only be identified by a screen name, for example. In either instance, however, the present invention assures that only the legitimate user can access their account and post content and communicate with others from that account. An impersonator that approaches the OSN as a claimant will be prevented from logging into any account that the claimant is not authorized to access.

Turning next to the problem of misrepresentations in an OSN, during the enrollment process users can make certain representations about themselves, whether they disclose their true identity or remain anonymous behind a fabricated screen name. Such representations include gender, age, race, hair color and so forth. Embodiments of the present invention allow certain representations to be authenticated. Users that are willing to have their representations verified by the OSN, in some embodiments, are classified as certified users. Certified and uncertified users represent two classes of users in the OSN, and the two classes can be afforded different rights and subjected to different rules by the OSN.

For instance, the enrollment process can comprise an enrollee speaking to a video camera in response to a prompt. Here, the authentication system 1110 is able to capture both a facial recognition template and a voice template of the enrollee. The OSN can then attempt to verify representations made during the enrollment process.

Verifications of representations made during the enrollment process, or subsequently, can be performed manually or automatically. For example, a person acting on behalf of the OSN can manually compare age and gender representations made by an enrollee against the enrollee's facial recognition template and make a determination as to whether the enrollee is making false representations. Some automated systems, such as VoiceVault, are able to estimate a person's age and determine the person's gender based on voice samples. Accordingly, the authentication system 1110 can be configured to automatically screen enrollees to verify age and gender representations. Representations that fail the screen, in some cases, can be reviewed by a person acting on behalf of the OSN.

As already noted, in some embodiments, an OSN that screens enrollees for misrepresentations can classify those users that pass the screening as certified users. In some OSNs, submission to the screening process is optional so that an enrollee can opt to become a certified user or not, either at the time of enrollment or subsequently. In those embodiments in which certification is optional, users can be enticed to become certified, for example, through rate reductions, special offers, or the availability of additional features and/or services that are made available only to certified users.

Certified users can be identified as such to other users of the OSN, in some embodiments, for example with a frame around a profile picture. Additionally, where an OSN has a sub-population of certified users, the OSN can offer parental controls that limit contact to only certified users, and further, to only those certified users that fit one or more criteria. In this way, a parent can limit a child's access through an OSN to only those certified users that are girls under the age of 20, for example.

Within the context of an OSN, the invention can also allow one user to authenticate a certified user to help the first user assess the certified user's trustworthiness before accepting messages, communications, content, or the like.

The OSN, in some embodiments, provides a mechanism by which a user can report suspected frauds or misrepresentations, either to the OSN itself, and/or to other users, and/or to police.

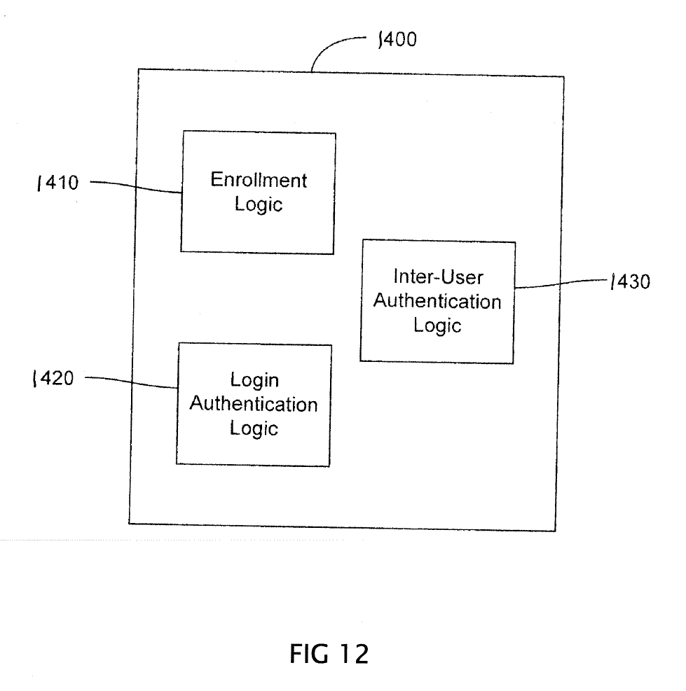

Beyond the actual preventative actions noted above, the present invention can also have a deterrent effect on those seeking to either misrepresent themselves or impersonate others within an OSN. Enrollment and authentication logic (see FIG. 12, below) can each be configured to require that the enrollee, or claimant, provide a video image and can be further configured to notify the enrollee or claimant that the information being submitted is being recorded and stored. Thus, the enrollee or claimant is on notice that his image, and other data such as voice samples, are being recorded and can be used like fingerprints from a crime scene to help identify the enrollee or claimant should the OSN be used for illegal purposes. While such notice alone may not bar a claimant from making misrepresentations or attempting to impersonate another user, as noted elsewhere herein, such notice can provide a powerful deterrent against trying.

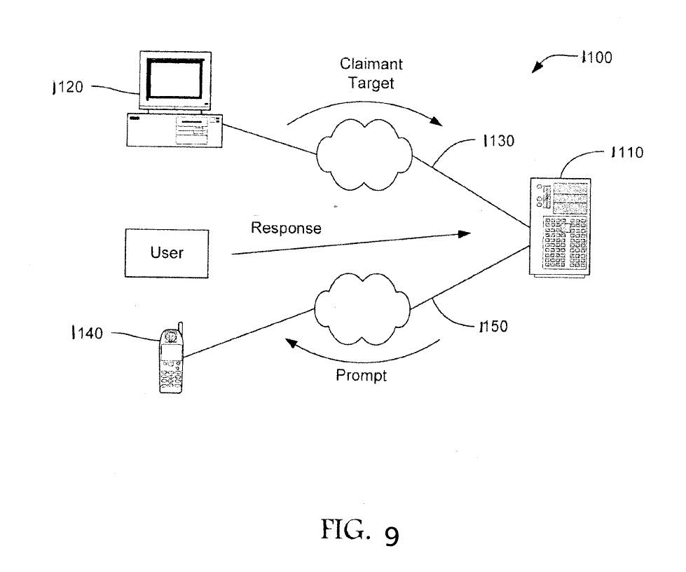

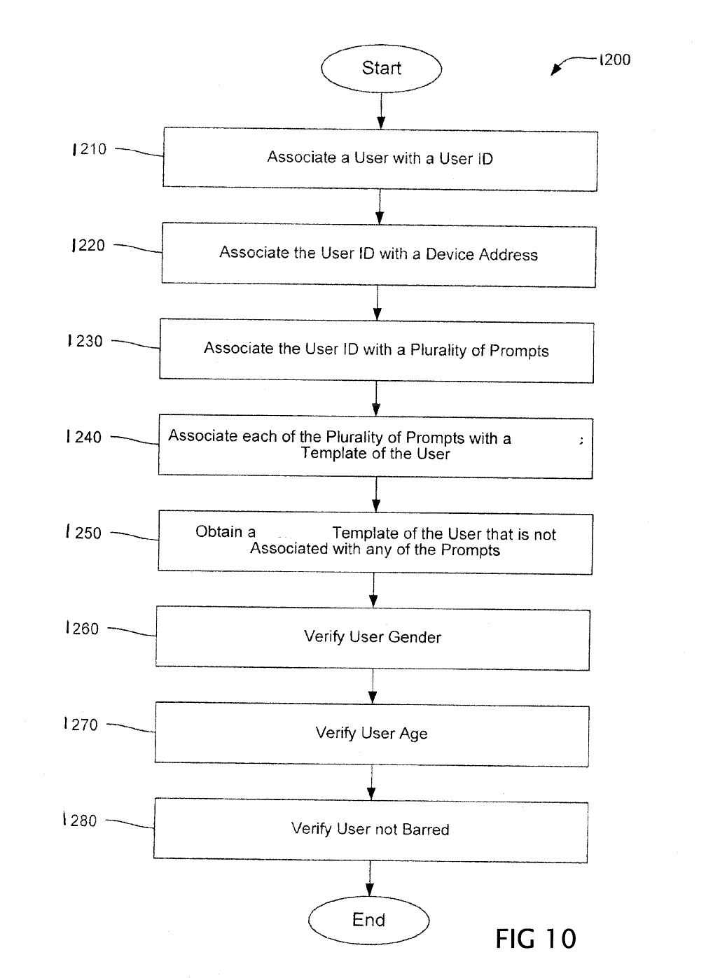

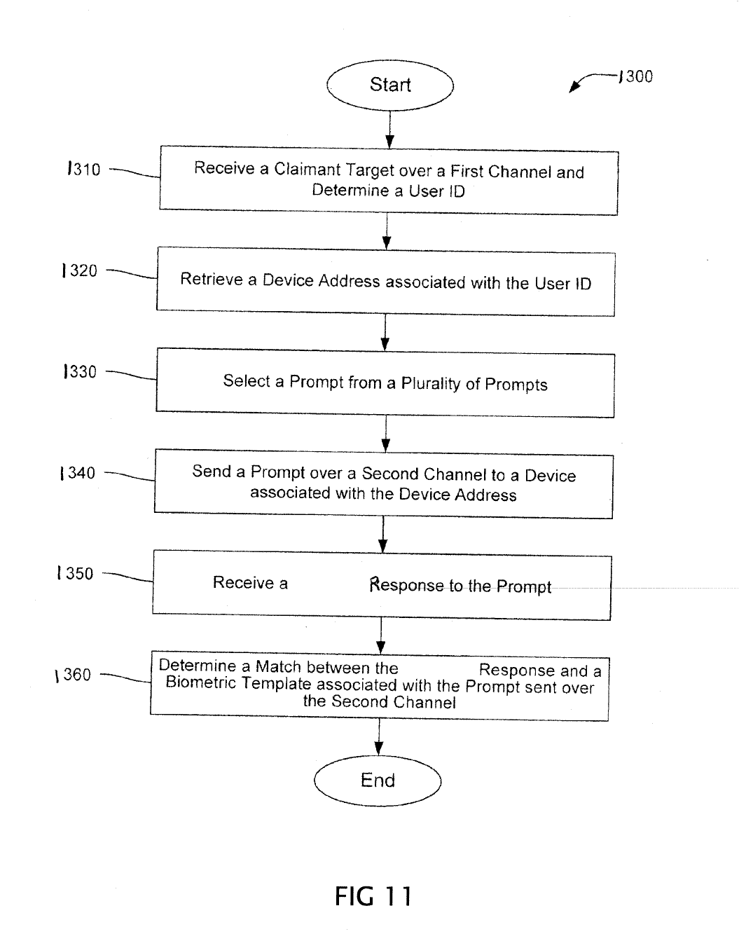

FIG. 9 shows an exemplary environment 1100 for carrying out various methods described herein. The environment 1100 comprises an authentication system 1110 in communication with a first device 1120 over a first communication channel 1130, and in communication with a second device 1140 over a second communication channel 1150. The authentication system 1110 can comprise one or more servers, data storage devices, workstations, and the like, networked together and configured to perform the functions described herein. The authentication system 1110 is preferably implemented in a secure environment to prevent both external and internal tampering. In some embodiments, the authentication system 1110 is part of an OSN computing system, such as the computing systems that provide the functionality of an OSN, like FaceBook and MySpace) to its users. The authentication system 1110 is configured to implement authentications, described in more detail with respect to FIG. 11, and in some embodiments the authentication system 1110 is also configured to implement user enrollment. Alternatively, enrollment can be implemented by a separate system in communication with the authentication system 1110. The enrollment process is described in detail with respect to FIG. 10.

To implement an authentication, in various embodiments, the authentication system 1110 receives a claimant target from the first device 1120, sends a prompt to the second device 1140, receives a response from either the first device 1120 or the second device 1140, and compares the response with the sample that was previously associated with the prompt. Upon completion of a successful authentication, the authentication system 1110 may communicate the successful result to either or both of the authenticated user and other parties to a transaction. The authentication system 1110 is discussed further with respect to FIG. 12.

The first device 1120 is a communication device that can communicate a claimant target to the authentication system 1110. Exemplary first devices 1120 include servers, personal computers (PCs), laptops, personal digital assistants (PDAs), cell phones, smart phones (such as Treos, BlackBerries, etc.), kiosks, and so forth. The claimant target can simply be, for example, the user ID associated with the user during the enrollment process.

In those instances where the claimant target is a string of alphanumeric characters, an e-mail address, or the like, the first device 1120 can comprise a keypad, keyboard, touch-sensitive screen, or the like on which the claimant target can be entered. Where the claimant target is a input, the first device 1120 can comprise a camera capable of taking still images and/or providing video images. The first device 1120 can also include other entry devices such as a touch pad for recording signatures, an iris scanner, a fingerprint reader, and so forth.

It should be noted that in some instances the claimant sends the claimant target from the first device 1120, while in other instances another party to the transaction, such as a merchant, a financial institution, or another individual sends the claimant target to/from the first device 1120. Thus, in the former situation the first device 1120 may be a device in the claimant's home, such as a PC, interactive TV system, gaming console, or the like, or a hand-held device that the claimant carries, such as a smart phone or PDA. The claimant can also send the claimant target from a first device 1120 such as a kiosk or a terminal in a retail store, for example. In the latter situation, where the other party sends the claimant target, the first device 1120 may be physically remote from the claimant, such as a web server (this is sometimes referred to as a Cardholder-Not-Present (CNP) transaction environment). In some of these embodiments, the first device 1120 stores the claimant target (e.g., an on-line retailer can store the claimant targets of registered shoppers for their convenience) or receives the claimant target from the claimant at the beginning of the authentication process. In still other embodiments, the first device 1120 can be a surveillance station, such as a closed-circuit TV (CCTV) camera, that sends a video feed to the authentication system. The video feed includes images of faces of people, and those images constitute claimant targets. As one example, a store can monitor people entering through a door and begin the authentication process for quicker and easier checkout.

The second device 1140 is something the enrolled user possesses, or at least has ready access to. Exemplary second devices 1140 include cell phones, PDAs, smart phones, pagers, PCs, home phones, etc. The second device 1140 is something that is unique to the user in as much as the second device 1140 is characterized by a unique device address such as a phone number, IP address, URL, e-mail address, etc. In various embodiments, the second device 1140 is able to receive and render a prompt from the authentication system 1110 and/or transmit a response thereto. The prompt can be provided by the second device 1140 visually, aurally, or in combination, for example. For instance, the prompt can be displayed as a text message, a verbal command or cue, an audio clip, a video clip, etc. In some instances, the second device 1140 can be used by the claimant to provide the response to the authentication system 1110. Towards this end, the second device 1140 can include a camera capable of taking still images and/or providing video images. The second device 1140 may also include other entry devices such as the ones noted above.

It should be appreciated that the use of still images or video images as the response for authentication purposes provides a powerful security feature, in some embodiments. In particular, part of the prevalence of identity theft and electronic fraud lies in the anonymity associated with electronic transactions. It is a very strong deterrent to such malfeasance, however, to have to expose one's face to surveillance in order to perpetrate the fraudulent activity. With the advent of readily available and inexpensive webcams and cameras on cell phones, for example, the widespread implementation of a system that employs video for responses becomes practical.

This is especially useful for OSNs, where a need has existed since the inception of on-line communities for the ability for users to positively authenticate one another. Presently, the typical login system that requires a combination of a username and a password does not provide positive authentication of users to the extent that one user cannot tell whether the other user is misrepresenting them self or impersonating another. Thus, even if a user of an OSN chooses to employ a screen name and otherwise remain anonymous (i.e., not positively identified), the user still records responses that allows the person to log back into the OSN, and that can optionally be shown to other users and/or used to prevent the login and the re-enrollment of users that should become barred from the OSN. Thus, the present invention provides OSNs the ability to positively authenticate users at login, allows users the ability to positively authenticate each other, and allows the OSN the ability to exclude users that violate rules, for example.

The first and second communication channels 1130, 1150, extend between the authentication system 1110 and the first and second devices, 1120, 1140, respectively. The first and second communication channels 1130, 1150 can be fully duplexed and can each comprise connections made through networks, represented generally by clouds in FIG. 9, such as the public switched telephone network (PSTN), wireless telephone networks, the Internet, wide area networks (WANs) and local area networks (LANs). It should be noted that although each of the first and second communication channels 1130, 1150 are represented in FIG. 9 as connecting through only one such cloud, either communication channel 1130 or 1150 can comprise a connection through more than one network and both communication channels 1130 and 1150 can cross the same network.

It will also be understood that the authentication system 1110 can comprise further channels to facilitate communications with other parties to a transaction with a claimant. As described more fully below, a merchant may request an authentication over a third channel (not shown), the authentication then proceeds over the first and second channels 1130 and 1150 between the claimant and the authentication system 1110, and then confirmation of the authentication is sent to the merchant over the third channel.

FIG. 10 illustrates an exemplary method 1200 for enrolling a user, for example, into an on-line community such as an OSN. The method 1200 comprises a step 1210 of associating a user with a user ID, a step 1220 of associating the user ID with a device address, a step 1230 of associating the user ID with a plurality of prompts, and a step 1240 of associating each of the plurality of prompts with a template or signature of the user. The method 1200 can also comprise, in some embodiments, a step of obtaining a template of the user that is not associated with any of the prompts. The method 1200 can be implemented, in some embodiments, by communicating with an enrollee user through a kiosk or over the Internet. It should be appreciated that method 1200 can be fully performed by a computing system interacting with the enrollee user and does not require, in some embodiments, the intervention of a trusted individual acting on behalf of the on-line community.

In the step 1210, the enrollee user is associated with a user ID. This can comprise, for example, assigning a unique numeric or alphanumeric code to the user, or having the user select a unique numeric or alphanumeric code. In some embodiments a password is optionally assigned to, or selected by, the user as an additional security feature. The user ID can also be, in some instances, a template. For example, a file containing a list of features extracted from the user's fingerprint (i.e., a fingerprint template) is one such possible user ID. In some embodiments more than one user ID is associated with the user so that the user can seek authentication multiple ways, such as by entering a code or presenting a finger to a scanner, for example. Step 1210 can further comprise providing the user with a token including the user ID, such as a magnetic swipe card, a fob, an RFID tag, etc.

As described in the subsequent steps of the method 1200, the user ID is further associated with additional information pertaining to the enrollee user. The user ID and such further information can be stored as records in relational databases, or in other data storage configurations, for later retrieval during an authentication. In addition to the information described below in steps 1210-1250, other information that can be associated with the user ID through the enrollment method 1200 includes addresses, spending limits, access levels, and other third party management information system attributes. Such additional information can be stored locally, or can constitute a link or pointer to a record in an external database.

In step 1220 a device address is associated with the user ID. The device address is unique to a communication device that the user has, or has ready access to, such as the second device 1140 (FIG. 9). Step 1220 can include receiving the device address from the user, for example, where the user enters the device address into a text box in an on-line enrollment form. In some embodiments, receiving the device address from the user comprises reading the device address directly from the communication device. In some instances, where the user has more than one communication device, a device address for each can be associated with the user ID.

The user ID is further associated with a plurality of prompts in step 1230. The prompts can include common prompts such as “Say your mother's maiden name,” and “Sign your name on the signature pad.” In some embodiments, the user selects some or all of the plurality of prompts from a list of predefined prompts such as the common prompts noted above. The prompts selected by the user are then associated with the user ID. In other embodiments, a plurality of predefined prompts is automatically assigned to the user. In some embodiments, still other prompts that can be associated with the user ID are personalized prompts. As used herein, a personalized prompt is a prompt created by the user, for example, “Say the rhyme your daughter loves.” The personalized prompts can be recorded in the user's own voice, or entered as text, for example. The number of prompts in the plurality of prompts can be two or more, but preferably is a number that strikes a balance between the security offered by greater numbers of prompts and the burden on the user to enroll large numbers of prompts and associated responses. In some embodiments, the number of prompts is 5, 6, 7, 8, 9, or 10 at the time of enrollment, and may be increased subsequently.

It should be appreciated that the use of a personalized prompt for authentication purposes provides a powerful security feature, in some embodiments. In particular, part of the prevalence of identity theft and electronic fraud lies in the availability of information through contracts and electronic databases. Prompts including questions such as “what is your mother's maiden name?” and “what is the name of your youngest sibling?” are easily discovered through contracts or Internet searches. A personalized prompt such as “color of my teenage dream car” is not readily known and whose response cannot be easily identified even by a spouse. With the increase in identity theft and a significant part of identity theft being perpetrated by family members, personalized prompts present a significant hurdle for even a person's closest associates.

In step 1240 each of the plurality of prompts is associated with a template of the enrollee user. For example, where the prompt is an instruction to say some word or phrase, the template can be a voice template derived from the user saying the word or phrase. Here, associating the prompt with the template can include providing the prompt to the user and receiving audio data (e.g., a .wav file) of the user's response. Associating the prompt with the template can further include, in some instances, processing the received audio data to extract the template. The template can be, in some embodiments, a filtered or enhanced version of the originally received audio data, such as with background noise removed, or averaged over multiple repetitions by the user. The template can also include a set of markers or values derived from the audio data.

Other examples of templates include fingerprint templates derived from users' fingerprints; signature templates derived from users' signatures, and in some instances also derived from aspects of the act of creating the signature such as rate and pressure of the writing implement as a function of time; facial recognition templates derived from still or video images of users' faces; iris scan templates derived from users' iris scans; and so forth. A template can also comprise an unprocessed response, such as a .wav file of the user's voice, a .jpg file of an image of the user's face, etc. Both templates and prompts can be stored in association with the user ID in a database, for example.

It will be appreciated that the template associated with any particular prompt need not make sense to anyone other than the user, adding still another security feature in some cases. For example, the user can create the prompt “Monday morning” and associate with that prompt a template derived from saying “marvelous marigolds.” Even if someone were to sample enough of the user's voice to reasonably model the user's voice, it would be virtually impossible to know the correct response to the particular prompt.

In some embodiments step 1240 includes the use of voice recognition. Voice recognition is distinguished here from voice identification in that voice recognition can distinguish spoken words independent of the speaker, whereas voice identification associates the individual with the acoustics of the phrase without regard for the meaning of the words spoken. Thus, for instance, a user can create a personalized prompt by saying a phrase and then voice recognition can be employed by the authentication system to extract the phrase from a recording of the user saying the phrase. The extracted phase can then be stored as the template, as a component of the template, or as a completely separate record. Likewise, the system can prompt the user to say a few randomly selected words and use voice recognition to verify those words were spoken. In addition, voice identification (comparison) can be applied to the same sample to insure that the user spoke the randomly selected words thus verifying authenticity of the response.

Step 1250 is an optional step that comprises obtaining a template of the user that is not associated with any of the prompts. For example, enrolling the user can comprise capturing a digital image of the user's face. The image can be associated with the user ID but not with any particular prompt. Should the user have problems with a subsequent authentication and end up speaking with a live operator, provided that the communication with the live operator is over a video conference or something similar, then the operator can compare the stored digital image of the user's face with the image of the claimant. Additionally, method 200 can optionally comprise associating additional user information with the user ID. Examples of additional user information include home address, home phone number, credit card numbers, system preferences and user settings, and so forth.

In some embodiments, the enrollment method 1200 optionally includes a step 1260 of verifying the gender of the enrollee user. Step 1260 can comprise, in some embodiments, receiving an indication of the enrollee user's gender, and comparing the indication with the result of an analysis of a template from the plurality of templates. An example of an indication of the enrollee user's gender can be, for example, a representation of gender made through an on-line enrollment form. Some automated systems, such as VoiceVault, are able to determine a person's gender based on voice samples. An analysis by such an automated system of a voice sample, such as a voice template made by the enrollee user, yields a result, either male or female, that can be compared against the indication of gender to verify the gender. In the alternative to the automated analysis, a manual comparison can be performed in step 1260 in which a human evaluates the template for gender and compares the result to the indication of gender from the enrollee user.

In some embodiments, the enrollment method 1200 optionally includes a step 1270 of verifying the age of the enrollee user. Step 1270 can comprise, in some embodiments, receiving an indication of the enrollee user's age, and comparing the indication with the result of an analysis of a template from the plurality of templates. An example of an indication of the enrollee user's age can be, for example, a representation of age made through an on-line enrollment form. Some automated systems, such as VoiceVault, are able to estimate a person's age based on voice samples. An analysis by such an automated system of a voice sample, such as a voice template made by the enrollee user, yields a result, such as an age range, that can be compared against the indication of age to verify the age. In the alternative to the automated analysis, a manual comparison can be performed in step 1260 in which a human evaluates the template for age and compares the result to the indication of age from the enrollee user.

Yet another optional step 1280 comprises verifying that the enrollee user has not been barred from the OSN. For example, step 1280 can comprise comparing a template of the plurality of templates of the first user against a plurality of templates of barred users. If the result of the comparison is a match, indicating that the enrollee user is the same individual as one who has previously been barred from the OSN, than enrollment can be denied to the enrollee user based on the match.

FIG. 11 illustrates an exemplary method 1300 for authenticating a claimant, such as a user of an OSN seeking to log back in to their account. The method 1300 comprises a step 1310 of receiving a claimant target over a first channel, a step 1320 of retrieving a device address associated with the user ID, an optional step 1330 of selecting a prompt from a plurality of prompts where each of the plurality of prompts is associated with a template of a user, and a step 1340 of sending a prompt, such as the prompt selected in step 1330, over a second channel to a device associated with the device address. The method 1300 further comprises a step 1350 of receiving a response to the prompt, and a step 1360 of determining a match between the response and a template associated with the prompt sent over the second channel.

In step 1310 a claimant target is received over a first channel. In some embodiments the claimant target comprises a user ID, while in other embodiments the method 1300 further comprises determining the user ID from the claimant target. In some embodiments where the claimant target comprises the user ID, the user ID can be a numeric or alphanumeric character string, for example, such as an e-mail address or a user name selected by an enrollee user during the enrollment method 1200 (FIG. 10). In other embodiments where the claimant target comprises the user ID, the user ID is a template such as a fingerprint template or an iris scan template. As one example, a fingerprint scanner on a kiosk scans the claimant's fingerprint, reduces the scan to a fingerprint template, and then sends the template to the authentication system which receives the template as the claimant target.

As note previously, in some instances the claimant target is not the user ID itself, and in these embodiments the method 1300 further comprises determining the user ID from the claimant target. Returning to the prior example of the claimant at the kiosk, the kiosk could instead transmit to the authentication system the scan of the fingerprint without further processing. Here, the authentication system would further determine the user ID from the claimant target by reducing the scan to the fingerprint template.

In some embodiments, step 1310 also comprises receiving an authentication request, which in some embodiments precedes receiving the user ID and in some embodiments includes the user ID. For example, a claimant seeking to complete a transaction with another party can send an authentication request including her user ID to the authentication system. Similarly, the authentication request, including the user ID, may come from another party, such as a merchant. In still other embodiments, either the claimant or the other party to the transaction can make the request for authentication and subsequently the claimant is prompted by the authentication system to submit the user ID. It should be noted that in some embodiments that claimant also supplies a password with the user ID, while in other embodiments a password is not required. Thus, in these latter embodiments, step 1310 specifically does not comprise receiving a password.

After step 1310, a device address associated with the user ID is retrieved in step 1320. The device address can be retrieved, for example, from a database that associates device addresses with user IDs. Step 1320 can also comprise retrieving a record associated with the user ID, where the record includes one or more device addresses as well as other information such as prompts and templates.

In optional step 1330 a prompt is selected from a plurality of prompts, where each of the plurality of prompts has a template of the claimant associated therewith. In some embodiments, the plurality of prompts is ordered, say from first to last, and the act of selecting the prompt simply comprises identifying the next prompt in the order based on the last prompt used. Other embodiments employ randomization algorithms. A rule can be implemented, in some embodiments, that the same prompt from the plurality of prompts cannot be used in successive authentications. Similar rules can be implemented to prevent the same prompt from being employed twice within any three authentications, and so forth. Yet another rule that can be implemented applies where several of the templates each include voice data comprising at least two syllables. Here, the rule requires that the same two syllables used in one authentication cannot be used in the next subsequent authentication.

In step 1340, a prompt is sent over a second channel to a device associated with the device address. The device may be a cell phone, PDA, smart phone, PC, and so forth. In the limiting case where there is only a single prompt associated with the user ID, for example, the step 1330 of selecting a prompt from a plurality of prompts is unnecessary and step 1340 simply comprises sending the one prompt. Where the prompt is selected in step 1330 from a plurality of prompts, step 1340 comprises sending the selected prompt. In some instances, the prompt is sent in a text message according to the Short Message Service (SMS) communications protocol. In other embodiments, the prompt is delivered as a voice transmission such as an audio recording or as synthesized speech. The prompt can similarly comprise a video transmission. The prompt can also be sent as an e-mail or an Instant Message.

It should be noted that instructions can also be sent to the claimant, over either channel, in addition to the prompt. As one example, the claimant submits a claimant target over a first channel from a PC, and receives a prompt on her cell phone over a second channel. The prompt is a text message of the word “Rosebud.” An instruction can be sent over the first channel to be displayed on the PC such as “A prompt has been sent to you. After the red light appears on your screen, face the webcam and provide your response to the prompt.” Still another security feature lies in the fact that it is not readily apparent from an instruction how the prompt should be received. Someone intercepting the instruction would not readily know whether the prompt was sent to a web browser, in an e-mail, or to a mobile device, for example.

After step 1340, a claimant receives the prompt and acts accordingly to produce some response. For example, the claimant can speak to a microphone, present her face or another body part to a camera, make a gesture in front of a camera, press her finger on a fingerprint scanner, present her eye to a retinal scanner, write on a touch-sensitive pad, or combinations of these. The response is therefore some product of the claimant's actions such as a voice data, a fingerprint scan, retinal scan, or an image of the person's face or body part, for example. The response can comprise unprocessed data, partially processed data, or can be completely reduced to a template, for example.

The method 1300 further comprises the step 1350 of receiving the response to the prompt. The response can be received from the same device that received the prompt, or in other embodiments from the same device that sent the claimant target. The response may even be received from a third device over some third channel, in some embodiments.

Step 1360 comprises determining a match between the response and a template associated with the prompt sent over the second channel. In a simple example, the template comprises a facial recognition template of a user and the response comprises a segment of streaming video that includes frames showing the claimant's face. Here, determining the match comprises extracting a facial recognition template of the claimant's face from the frames of the video segment and comparing that facial recognition template to the original facial recognition template of the user.

It will be appreciated, moreover, that step 1360 can comprise matching more than one template to the response. For instance, in the above example, the segment of streaming video can also include the claimant saying a phrase. Here, a voice template can be extracted in addition to extracting a facial recognition template. In this example a match can be determined between a voice template and the voice in the video, and a match can be determined between a face template and the face in the video.

In various embodiments, determining the match between the response and the signature comprises determining a figure of merit that characterizes the agreement between the response and the template, and then comparing that figure of merit to a threshold. If the figure of merit exceeds the threshold, or in some instances equals or exceeds the threshold, then the match has been determined. Where more than one template is compared to the response, in some embodiments, a figure of merit for each template is calculated and each figure of merit is compared to the relevant threshold.

In those embodiments where the response comprises a vocal response from the claimant, determining the match between the response and the template in step 1360 can comprise performing voice recognition on the response to determine whether the correct word or words were spoken. Voice recognition has the benefit of being less computationally intensive than voice identification, therefore, a useful screen can be to employ voice recognition to determine whether the correct word or words are present in a response.

If the match cannot be determined, an optional step of the method 1300 comprises repeating method 1300 beginning at step 1320, preferably by selecting a different prompt in step 1330 than in the previous iteration. Another optional step if the match cannot be determined comprises establishing a live interview between the claimant and a customer service representative. The customer service representative, in some instances, has the authority to authenticate the claimant based on the interview. As noted previously, the customer service representative may be able to employ templates that are not associated with any of the prompts to decide whether to authenticate the claimant.

FIG. 12 shows an exemplary embodiment 1400 of the authentication system 1110 (FIG. 9). The authentication system 1400 of FIG. 12 comprises logic 1410 configured to enroll users, login authentication logic 1420 configured to authenticate claimants, and optionally inter-user authentication logic 1430 configured to authenticate one user to another. In various embodiments, logics 1410, 1420, and 1430 each can comprise hardware, firmware, software stored on a computer readable medium, or combinations thereof. Logics 1410, 1420, and 1430 may include a computing system such as an integrated circuit, a microprocessor, a personal computer, server, distributed computing system, communication device, network device, or the like. For example, logics 1410, and 1430 can be implemented by separate software modules executed on a common server. In other embodiments, logics 1410, 1420, and 1430 can be implemented on different computing systems. Logics 1410, 1420, and 1430 can also be at least partially integrated together.

The authentication system 1400 can also comprise, as part of the logics 1410, 1420, and 1430 or separate therefrom, volatile and/or non-volatile memory such as random access memory (RAM), dynamic random access memory (DRAM), static random access memory (SRAM), magnetic media, optical media, nano-media, a hard drive, a compact disk, a digital versatile disc (DVD), and/or other devices configured for storing digital or analog information. Logic 1410 can comprise, for instance, volatile and/or non-volatile memory as the computer readable medium on which software is stored for performing the methods described herein. Other volatile and/or non-volatile memory can comprise databases or other means for maintaining information about enrolled users including prompts, templates, responses supplied in response to prompts, device addresses, and the like that are accessed by the logics 1410, 1420, and 1430. Such information can be created and revised by login authentication logic 1420 and accessed by enrollment logic 1410 and inter-user authentication logic 1430.

The authentication system 1400 can also comprise communications logic (not shown) that allows the logics 1410, 1420, and 1430 to communicate, for example, with the first device 1120 (FIG. 9) over the first communication channel 1130 (FIG. 9) and the second device 1140 (FIG. 9) over the second communication channel 1150 (FIG. 9). In some embodiments the communications logic allows the login authentication logic 1420 to interface with multiple devices in parallel to support the simultaneous enrollment of multiple users. At the same time, the communications logic allows the logic 1410 to independently interface with multiple other devices to support the simultaneous authentication of multiple claimants.

The enrollment logic 1410 is configured to enroll a user by performing an enrollment method such as method 1200 (FIG. 10). In an exemplary embodiment, the enrollment logic 1410 is configured to associate the user with a user ID, associate the user ID and with a device address, associate a plurality of prompts with the user ID, and associate a number of templates each with one of the plurality of prompts. The enrollment logic 1410, in some embodiments, is configured to associate the plurality of prompts with the user ID by presenting a set of pre-defined prompts to the user and receiving a selection of the plurality of prompts from the set. In additional embodiments, the enrollment logic 1410 is further configured to allow the user to create a personalized prompt. The enrollment logic 1410 can also comprise a computer readable medium that stores software instructions for performing these steps.

The login authentication logic 1420 is configured to authenticate a claimant by performing an authentication method such as method 1300 (FIG. 11) before providing the claimant with access to a particular account in an OSN, in some embodiments. In an exemplary embodiment, the login authentication logic 1420 is configured to receive a claimant target over a first channel, retrieve a device address associated with a user ID, send a prompt from the plurality of prompts to a device associated with the device address over a second channel, receive a response to the prompt, and determine a match between the response and a template associated with the prompt. In some embodiments the claimant target comprises the user ID, while in other embodiments the authentication logic is further configured to determine the user ID from the claimant target. The authentication logic is further configured to send a key, in some instances, where the key can be used for encryption and/or creating a watermark. In some of these embodiments the prompt includes the key when sent. Encryption and watermarking are described in greater detail below. The login authentication logic 1420 can also comprise a computer readable medium that stores software instructions for performing these steps.

The inter-user authentication logic 1430 is configured to authenticate one user to another. For example, a first user sends an invitation to a second user. The second user recognizes the screen name of the first user as one used by a personal friend. Still, the nature of the invitation seems odd to the second user, so the second user requests authentication of the first user. The authentication logic 1430 receives the request and in response sends to the second user at least a portion of either a response of the first user, or at least a portion of a template of the first user. The portion of the response can be, for example, part of the response given to the login authentication logic 1420 during the most recent login by the first user. The portion of the template of the first user can be, for example, all or part of the template of the user that was acquired in step 1250 and not associated with a prompt. The second user can then see, for example, a video of the first user and confirm that it is the personal friend.

Similarly, the second user may not recognize the screen name of the first user, but the first user is certified. Again, the inter-user authentication logic 1430 receives a request for authentication of the first user and sends in response at least a portion of either a response of the first user, or at least a portion of a template. By viewing the content from the inter-user authentication logic 1430, the second user can better decide whether to accept the invitation from the first user.

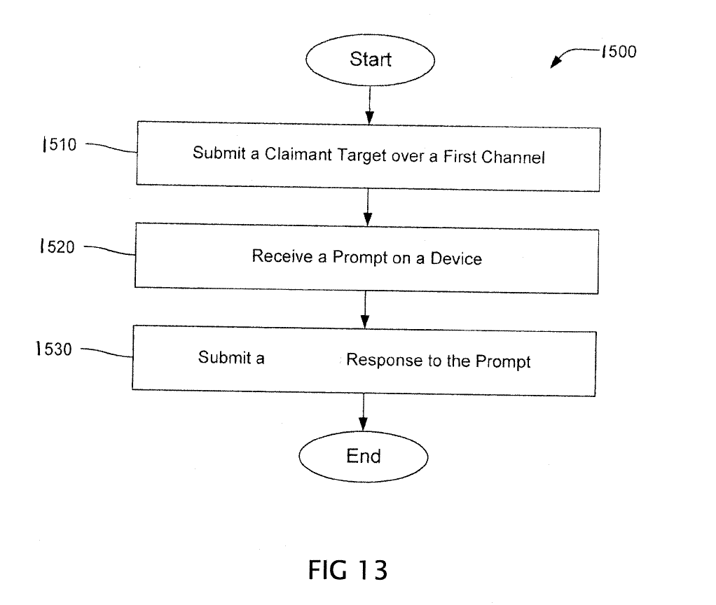

FIG. 13 shows an exemplary authentication method 1500 that can be performed, for example, by a claimant such as to access an on-line account in an OSN. The method 1500 comprises a step 1510 of submitting a claimant target over a first channel, a step 1520 of receiving a prompt on a device, and a step 1530 of submitting a response to the prompt. In method 1500, one of the two steps of receiving the prompt and submitting the response is performed over a second channel. In some embodiments, the claimant performing the method 1500 only has to perform these three steps to be authenticated. As was the case with the enrollment method 1200, it should be appreciated that method 1500 can also be performed in the absence of a trusted individual acting on behalf of the on-line community. In other words, whereas prior authentication systems rely on the presence of a trusted individual to assess authenticity, in method 1500 the claimant does not need to interact with a trusted individual but can interact instead merely with a computing system.

In step 1510, the claimant submits the claimant target, such as the user ID, to an authentication system, for example, or to some intermediary such as a merchant that then relays the claimant target to the authentication system. Since the method 1500 can be performed by a claimant seeking to complete an electronic transaction from home, work, or in public, in step 1510 the claimant can submit the claimant target from a PC at home, from a kiosk in a shopping mall, or from at a terminal at a store check-out, for example. The claimant can submit the claimant target, according to various embodiments, by entering numbers and/or letters with a keyboard or keypad, swiping a magnetic card through a card reader, bringing an RFID tag within range of an RFID reader, writing with a stylus on a touch-sensitive pad, placing a finger on a fingerprint reader, speaking within range of a microphone, smiling for a camera, combinations thereof, and so forth.

Then, in step 1520, the claimant receives a prompt on a device that the claimant has, or has ready access to. The device that receives the prompt may be a hand-held device such as a cell phone, PDA, or smart phone, or the device can be some other communication device such as a PC, and so forth, as described above. As also previously noted, examples of the prompt include a text message, e-mail, an Instant Message, an audio recording, a video, or synthesized speech. In some embodiments, the prompt includes a warning that if the recipient of the prompt is not seeking authentication, then an unauthorized authentication attempt is in progress and to contact the Administrator.

Next, in step 1530, the claimant submits a response to the prompt. The claimant can submit the response, according to various embodiments, by writing with a stylus on a touch-sensitive pad, placing a finger on a fingerprint reader, placing one eye in proximity to an iris scanner, speaking within range of a microphone, speaking to a camera, combinations thereof, and so forth.

In method 1500 one of the two steps of receiving the prompt 1520 and submitting the response 1530 is performed over a second channel. For example, the claimant can submit the claimant target from a PC over a first channel in step 1510, and receive the prompt with a cell phone over a second channel in step 1520. Here, the claimant can provide the response in step 1530 over either the first channel or the second channel, in different embodiments. In another example, the claimant submits the claimant target from the PC over the first channel in step 1510, the claimant receives the prompt on the PC again over the first channel (e.g., the prompt can be the following text message: “say your mother's maiden name”), the claimant's cell phone rings, and in step 1530 the claimant submits the response over the cell phone, here the second channel.

It will be appreciated that a method performed by an authentication system in this last example is a variant of the method 1300 (FIG. 11) described above. In this variant, rather than sending the prompt over the second channel to the device associated with the device address in the step 1340, a second channel is instead established to a device associated with the device address. Subsequently, rather than receiving a response to the prompt in the step 1350 over an unspecified channel, instead a response to the prompt is specifically received over the second channel.

Additional security features that can be incorporated are further described below. For example, any of the electronic communications described herein can be encrypted according to well known encryption protocols. As another example, a watermark can be added to any response sent to the authentication system. For instance, a webcam comprising a camera and a microphone can be set with a key. The key is transmitted to the user either through a secure channel or a separate channel so that unauthorized users would not be aware of the key. The watermark can be based at least in part on the key. For instance, image data can be altered by discrete cosine transform (DCT) coefficients based on the key. Of course, other algorithms can be similarly employed. Audio data can likewise be watermarked. The key used for watermarking can also be the same key employed for encryption, in some embodiments.

In the previous example, the key for the watermark can be transmitted to the claimant at the time of authentication for still further security. For instance, the prompt received over the second channel can include the key (e.g., “Please enter the following key to your webcam, wait for the red light, and then say your birth date.”). For still further security, the webcam (or any other device for recording a response) can include a dedicated keypad for entering the key, where the keypad is not otherwise connected to any computing system. Here, there is no electronic way to intercept the key between the device that receives the key and the keypad of the webcam. For still further security the possible keys would be non-repeating so that a fraudulent authentication attempt can be determined by detecting the use of a previously used key. Even additional security can be achieved by having keys expire within a period of time, such as 30 seconds, after being issued.

In some embodiments, the entry device (e.g., webcam, fingerprint reader, etc.) does not have a dedicated keypad to enter a key. In some of these embodiments, the key can be entered through a shared keypad or keyboard. For example, a PC with an integrated webcam would allow the key to be entered on the PC's keyboard. Here, the PC can include logic that when activated, connects the keyboard to the entry device and simultaneously disconnects the keyboard from the computer and disables the ability of other programs running on the PC to access key press notifications, thus rendering spyware ineffective. In some of these embodiments, the logic can render an onscreen prompt to enter the key for the entry device. For further security, the logic can echo keystrokes and codes as asterisks or other characters so as not to expose the actual keystrokes.

In another embodiment, where a webcam or similar device acquires the response, two video streams can be produced. The first video stream is neither encrypted nor watermarked and is displayed on a screen for the benefit of the claimant, while the second stream is encrypted and/or watermarked and sent to the authentication system. Here, anyone observing the displayed first video stream would not be able to infer that the second video stream is watermarked and/or encrypted. Having the first video stream provides the claimant with the ability to center her image in the field of view of the camera. Here, allowing the claimant to see her displayed image can potentially expose the image data to being captured with spyware. To avoid this, a further security feature comprises replacing the raw video image of the claimant with a placement indicator, such as an avatar. In this way, the claimant can center herself in the field of view by watching a representation of the claimant on the screen.

A still further security feature is achieved through hybrid prompts. A hybrid prompt is a prompt that the user selected during enrollment that is modified during authentication. For instance, the user during enrollment selects the prompt “Say your favorite movie.” Subsequently, during authentication, the claimant receives the hybrid prompt “Say you favorite movie, then say spark plug.” Here, the original prompt has been modified to also ask for random words or a random phrase. Voice recognition can then be employed to determine whether the words added to the original prompt were spoken in the response. If so, voice identification can be applied to the portion of the response that includes the response to the original prompt. Furthermore, that portion of the response that includes the added random words can be saved as further templates from the user.

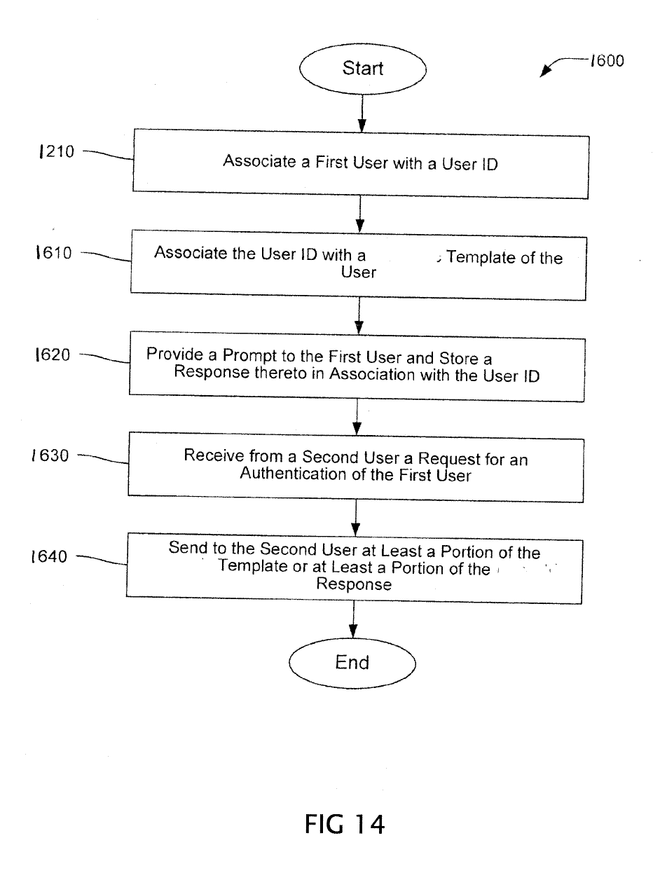

FIG. 14 is a flow-chart representation of an exemplary method 1600 for preventing a user from making certain misrepresentations in an OSN. The method 1600 comprises the step 1210 of method 1200 (FIG. 10) and additionally comprises a step 1610 of associating the user ID with a template of a first user. Step 1610 can comprise the steps 1230 and 1240 of method 1200, in some embodiments. Method 1600 also comprises a step 1620 of providing a prompt to the first user and storing a response of the first user thereto in association with the user ID. Step 1620 can comprise the steps 1340 and 1350 of method 1300 (FIG. 11), in some embodiments. It will be appreciated that various embodiments of method 1600 can include some or all of the other steps of methods 1200 and 1300. Each user of the OSN that follows the steps 1210, 1610, and 1620 provides the OSN with a user ID associated with two samples, one recorded as a template, the other provided in response to a prompt, for example, while logging into the OSN to access an account. It will be understood that in some embodiments, only the template or the response needs to be associated with the user ID.

Method 1600 also comprises a step 1630 of receiving a request from a second user of the OSN to authenticate the first user of the OSN. Here, the second user may wish to verify certain representations made by the first user. For instance, the second user can request authentication of the first user to verify that the first user is not an imposter impersonating the person associated with a particular screen name. In other instances, the second user can request authentication of the first user to verify that representations made by the first user about age, gender, personal appearance, and so forth are legitimate.

Method 1600 also comprises a step 1640 of sending to the second user at least a portion of the response of the first user, or at least a portion of the template of the first user. In those embodiments in which only the template or the response is associated with the user ID, step 1640 reduces to sending at least a portion of whichever sample was associated with the user ID. It will be appreciated that for certain purposes either of the response or the template may be more relevant. For example, to verify that a user is not an imposter, the response from the most recent login event would be more relevant than a template recorded when the an account was first established. Steps 1630 and 1640 can be performed by the inter-user authentication logic 1430 (FIG. 12) in some embodiments.

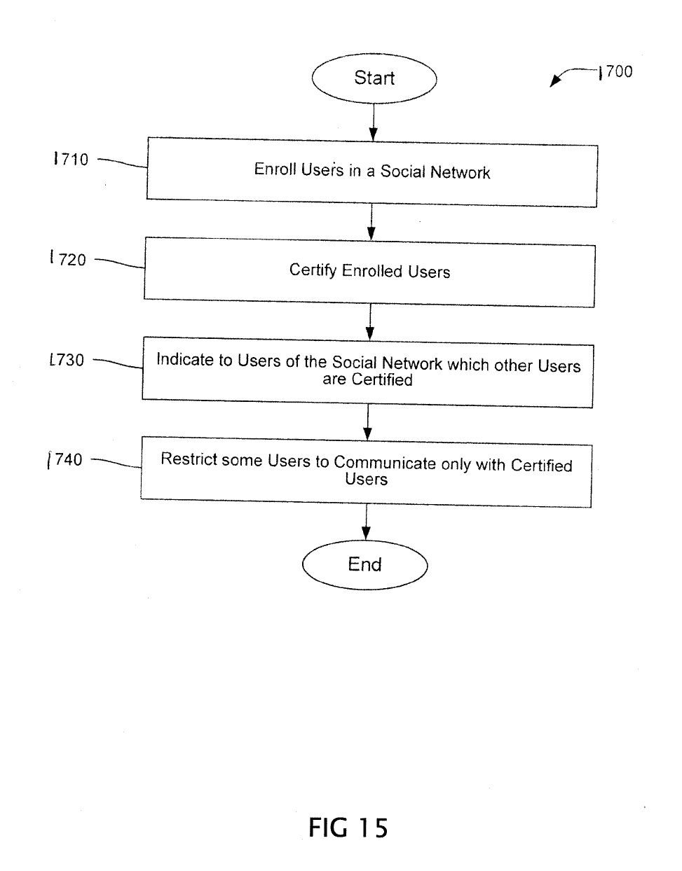

FIG. 15 is a flow-chart representation of an exemplary method 1700 for maintaining an OSN. The method 1700 comprises a step 1710 of enrolling users in the OSN, a step 1720 of certifying enrolled users, and a step 1730 of indicating to users of the OSN which other users are certified. Here, the step 1710 of enrolling users includes storing in association with a user ID for each enrolled user a voice template, a facial recognition template, the user's gender, and/or the user's age. The step 1720 of certifying enrolled users is performed by using the voice template or the facial recognition template to verify the gender and/or age of each certified enrolled user.

Step 1730 comprises indicating to users of the OSN which other users are certified. This can be achieved, for example, by a visual indicator associated with screen names or screen images of certified users. For instance, a screen names of certified users and/or their screen images communications from a user) can be highlighted is various ways. Alternatively, or in addition, an icon can be displayed in association with certified users' screen names and/or screen images to indicate the certified status.

An optional step 1740 further comprises restricting some users to communicate only with certified users. This can comprise, for example, restricting those users to communicate only with certified users that match a criterion like a gender or an age or age range. Step 1740 can be implemented, for instance, in the context of parental controls so that a child is restricted to communicating with, and exchanging content with, only those other users that are certified to be children below a certain age or within a specified range of ages.

Other embodiments of the invention will be apparent to those skilled in the art from consideration of the specification and practice of the invention disclosed herein. It is intended that the specification and examples be considered as exemplary only, with a true scope and spirit of the invention being indicated by the appended claims.

What is claimed is:

1. A method of monitoring activity relative to a user's account of an on-line social network website (OSN), comprising:
monitoring at least one activity of the user's account on an OSN resulting in user's account activity data;
conducting analysis of the user's account activity data; and
reporting information indicative of the processed user's account activity based on a selected criteria.

2. The method of claim 1, further comprising:
storing processed user's account activity.

3. The method of claim 1, wherein the at least some activities of the user's account are selected from at least one of, (i) postings including status updates, comments, notes and questions, (ii) keyword matching for discussions of at least one of drugs, sex, violence, illegal activity, suicide, and other topics of concern. (iii) at least one of uploading pictures, uploadingvideo, being tagged in photos, and being tagged in videos, (iv) identification of a user in at least one of a picture and video, (v) friend information, (vi) determination of suspiciousness, (vii) friend activity, (viii) messaging activity (ix)chat activity, (x) link sharing and (xi) events and (xii) location.

4. The method of claim 1, wherein the monitoring includes monitoring and aggregation of information across multiple OSNs.

5. The method of claim 1, wherein the monitoring includes monitoring and aggregation of information across multiple user accounts.

6. The method of claim 1, wherein the monitoring user activity is in response to a call from the user or the OSN triggered by activity relative to the user's account.

7. The method of claim 6, wherein the call is at least one of a web services call, a website request, and an API call.

8. The method of claim 1, wherein monitoring includes polling a monitoring service by at least one of, periodically, aperiodically, and on an event driven basis.

9. The method of claim 1, wherein the step of monitoring logs or records user activity.

10. The method of claim 1, wherein user activity data is represented in the form of a uniform resource locator (URL).

11. The method of claim 1, wherein monitoring is achieved by monitoring e-e-mail.

12. The method of claim 1, wherein user activity data is represented in the form of a feed.

13. The method of claim 1 wherein alerts and analysis are conveyed to the user by at least one of web site access, sent via e-mail, mobile notifications, push notifications, SMS, texting, phone calls, voice communication, RSS feed, and printed output.

14. The method of claim 1, wherein processing includes parsing the user activity data from the OSN and normalizing the parsed user activity data.

15. The method of claim 1, wherein storing includes storing the processed results in a centralized, searchable data store.

16. The method of claim 1, wherein processing includes performing on-the-fly analysis of the user activity data.

17. The method of claim 1, wherein reporting includes reporting user activity data represented by metadata.

18. The method of claim 1, wherein processing includes processing user activity data in a synchronous manner.

19. The method of claim 1, wherein authentication of an account is granted by at least one of, web access, software installation, mobile access, email access, voice communication, API calls, allowing permission with an application on the OSN, and allowing permission to a third party application on the OSN.

20. The method of claim 1, wherein feedback from past monitoring is used to improve the results of future analysis.

21. The method of claim 1, wherein the analysis of various activities is used to compute a score to convey a summary of the analysis.

22. An apparatus to monitor activity relative to a user's account of an OSN, comprising:
a monitoring unit configured to monitor at least some activities of the user's account on an OSN resulting in user's account activity data;
a processing unit configured to process the user's account activity data;
a storage unit configured to store the processed user account activity data; and
a reporting unit configured to report information indicative of the processed user's account activity based on a selected criteria.

23. The apparatus of claim 22, wherein the at least some activities of the user's account are selected from at least one of, (i) postings including status updates, comments, notes and questions, (ii) keyword matching for discussions of at least one of drugs, sex, violence, illegal activity, suicide, and other topics of concern. (iii) at least one of uploading pictures, uploadingvideo, being tagged in photos, and being tagged in videos, (iv) identification of a user in at least one of a picture and video, (v) friend information, (vi) determination of suspiciousness, (vii) friend activity, (viii) messaging activity (ix)chat activity, (x) link sharing and (xi) events and (xii) location.

24. The apparatus of claim 22, wherein the monitoring unit is configured to monitor and aggregate information across multiple user accounts.

25. The apparatus of claim 23, wherein the monitoring unit is configured to monitor and aggregate information across multiple user accounts.

26. An OSN system, comprising:
enrollment logic configured to enroll a child in the OSN to create a child account by associating the child with a user ID, and
authentication logic configured to authenticate a parent of the child, the authenticating logic executing parent authentication by at least one of, (i) parents sign up for a parent account and receive a unique code, the child enters its code in the child account and the parent or guardian and obtains validation of the account as it indicates that the child believes that the adult can monitor the account, (ii) the parent creates an account for the child, which then gives access as the child uses it, (iii) the parent is issued a code and conveys to the child to enter that code to confirm a relationship, and (iv) the child is issued a code and conveys to the parent to enter that code to confirm a relationship.

27. The system of claim 26, wherein child enrollment data is stored under a parents account.

28. The system of claim 26, wherein the parent obtains a special code which the parent then gives it to the child.

29. The system of claim 28, wherein the child enters the code providing at least one of, parental access, monitoring and other privileges.

30. The system of claim 28, wherein the parent creates the account for the child with a linking already in place.

31. The system of claim 29, wherein a plurality of templates are each associated with one of the plurality of prompts.

32. The system of claim 28, wherein the code issued by at least one of web access, email access, SMS, text, mobile notifications, push notifications, phone call, voice communication, and a physical medium.
